(19) United States
(12) Patent Application Publication
(10) Pub. No.: US 2006/0267796 A1
(43) Pub. Date: Nov. 30, 2006

(54) TRAFFIC CONTROL BOARD MOUNT FOR VEHICLES

(76) Inventors: Shaun Oskroba, Fort Collins, CO (US); Ervin Weinmeister, Loveland, CO (US); Steven Sakavec, Loveland, CO (US)

Correspondence Address: COCHRAN FREUND & YOUNG LLC, 2026 CARIBOU DR, SUITE 200, FORT COLLINS, CO, 80525, US

(21) Appl. No.: 11/380,380

(22) Filed: Apr. 26, 2006

Related U.S. Application Data
(60) Provisional application No. 60/675,271, filed on Apr. 26, 2005.

(51) Int. Cl. G08G 1/095

(52) U.S. Cl. 340/908

(57) ABSTRACT

A traffic control board is pivotally mounted on a mast that can be raised from a collapsed, stowed position on a vehicle to an extended, upright position so that the traffic control board is pivotal about a substantially vertical orientation axis to be visible from any of a variety of horizontal directions in relation to the vehicle.

### CROSS-REFERENCES TO RELATED APPLICATIONS

This application claims the benefit of U.S. Provisional Application No. 60/675,271, filed on Apr. 26, 2005, which is incorporated herein by reference.

### BACKGROUND OF THE INVENTION

1. Field of the Invention

The present invention relates generally to traffic control devices, and more specifically to a vehicle-mounted traffic control board.

2. Description of the Prior Art

Traffic flow boards are generally rectangular boards with a plurality of lights mounted in a pattern or configuration that is conducive to selective lighting to display traffic control arrows pointing either left, right, or both left and right. They are often mounted on trailers or carts that can be transported to sites that need additional traffic flow directional controls or indicators, such as near road construction sites, accident sites, public events that draw extraordinarily large amounts of traffic, and the like. There is a need to make such traffic flow boards more portable and easier to deploy, including mounting them on motorized vehicles, such as police cars or other emergency or public service vehicles. However, most common traffic control boards are fairly large, for example, about 30×36 inch rectangular shapes, and they are quite bulky. Therefore, they are difficult to mount and use on the roofs of police cars and other motor vehicles, because they extend far above or beyond a normal vehicle profile. Also, it is easy to position and turn a trailer or cart with a traffic board at any desired orientation for best visibility, but police cars are not so easy to park in any orientation, especially where space is limited and when time to do so is even more limited. Therefore, there is a need for a better and more versatile traffic control board mounting for police cars and other vehicles.

### BRIEF DESCRIPTION OF THE DRAWINGS

The accompanying drawings, which are incorporated in and form a part of the specification, illustrate the preferred embodiments of the present invention, and together with the written description and claims, serve to explain the principles of the invention. In the drawings:

FIG. 1 is a perspective view of the traffic control board mounting apparatus;

FIG. 2 is a perspective view of the traffic control board mounting apparatus shown mounted on the roof of a police vehicle and rotated for example to be visible primarily from the left side of the vehicle;

FIG. 3 is a perspective view of the traffic control board mounting apparatus shown mounted on the roof of a police vehicle and rotated for example to be visible primarily from the right rear side of the vehicle;

FIG. 4 is an enlarged perspective of a portion of the traffic control mounting apparatus that includes the mast, the mounting plate for the traffic control board hinged to the mast, and the pivot actuator connected between the mast and the mounting plate; and

FIG. 5 is a perspective view of the traffic control board mounting apparatus shown mounted on the roof of a police vehicle and collapsed in the stowed position.

### DETAILED DESCRIPTION OF THE PREFERRED EMBODIMENTS

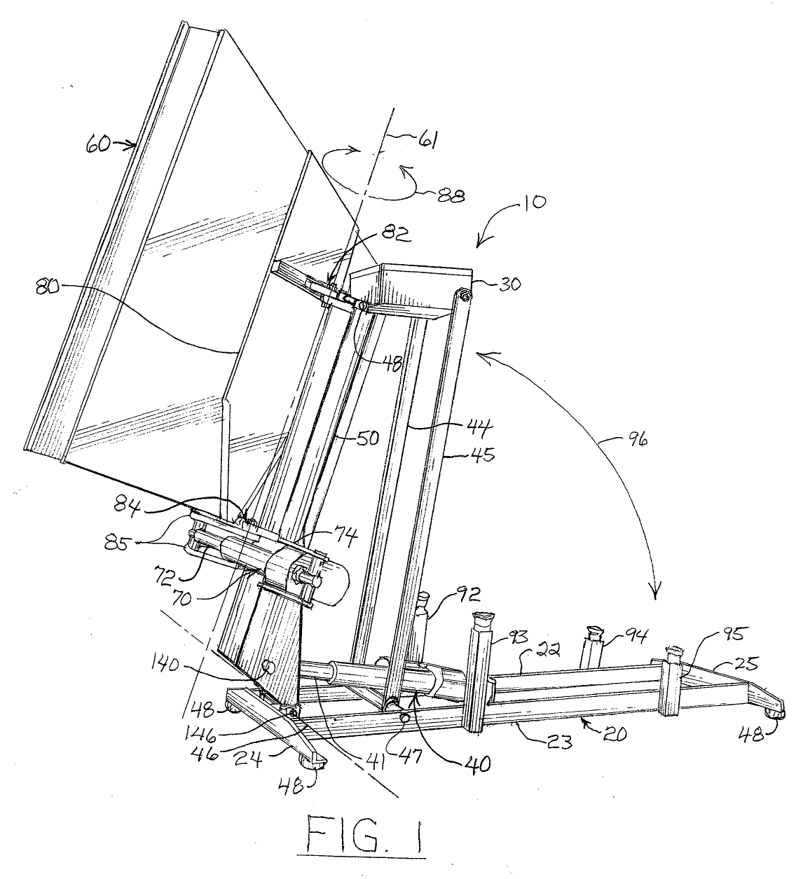

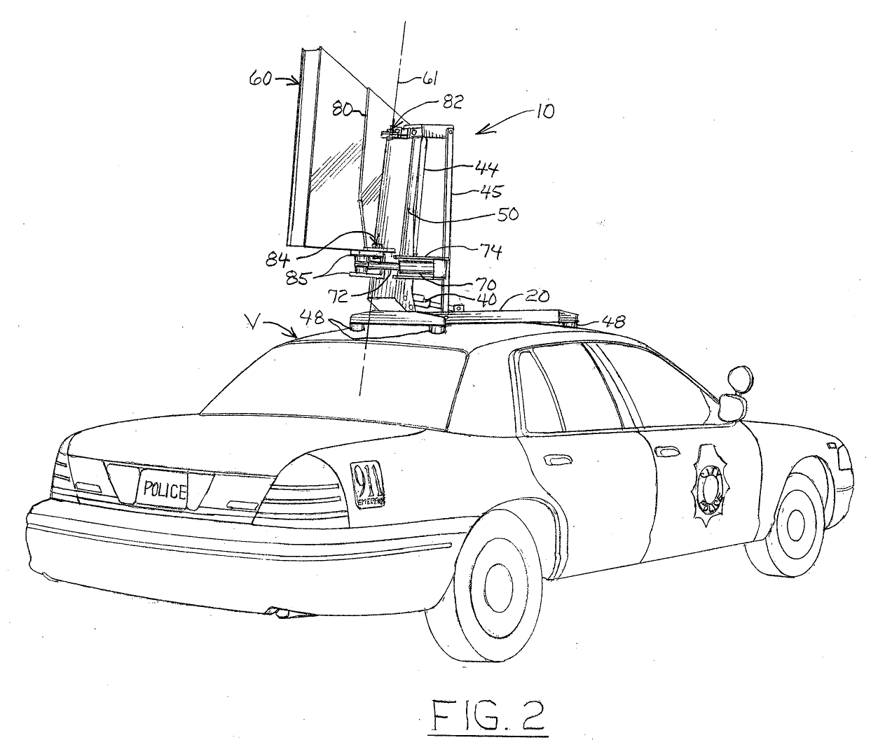

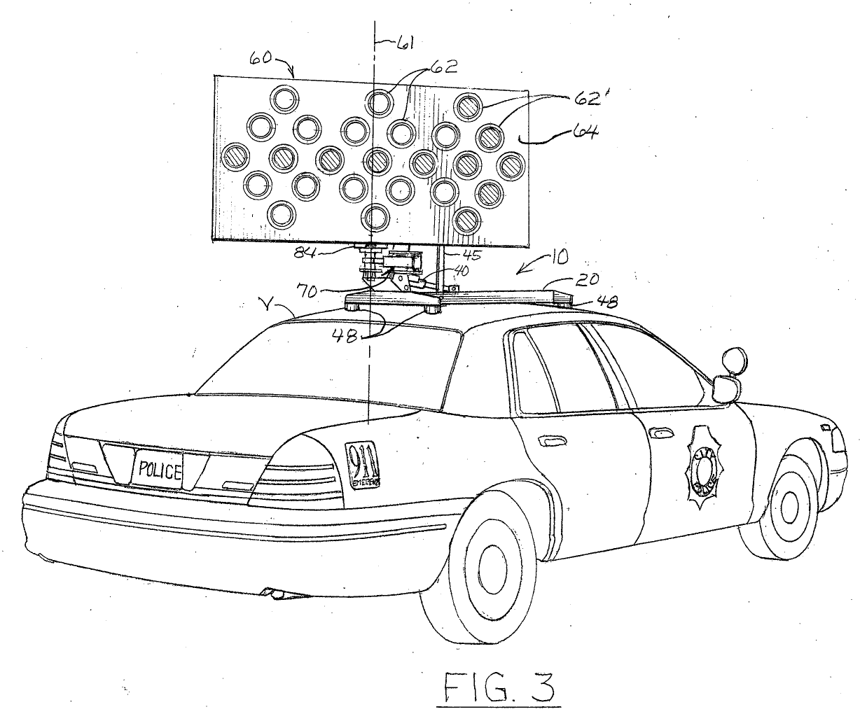

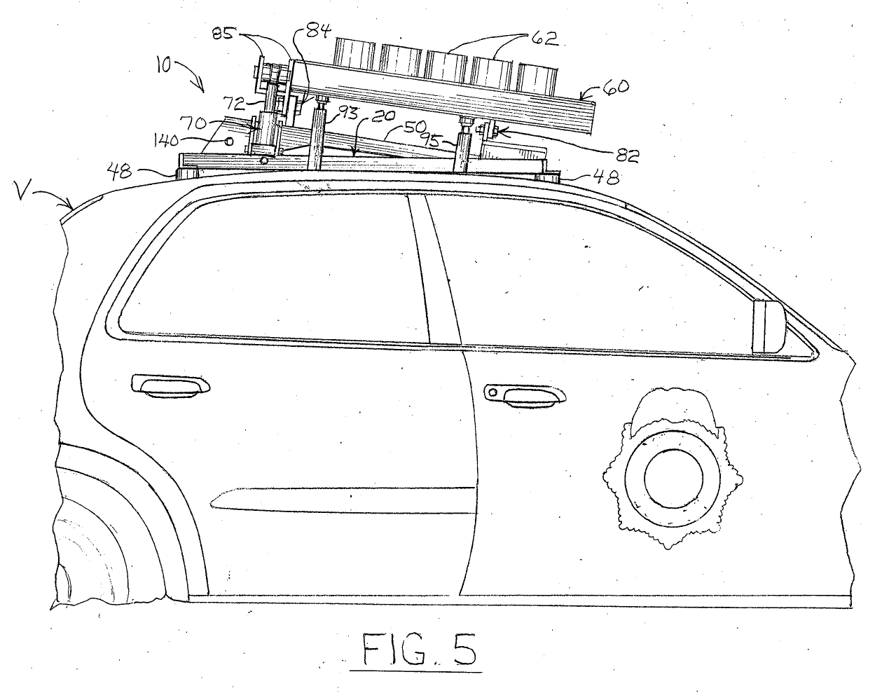

A traffic control board mount 10 is shown in FIG. 1 with the traffic control board 60 raised to use position and rotated from center about an axis 61 that extends through hinges 82, 84. The traffic control board mount 10 is shown in FIGS. 2 and 3 mounted on the roof of a motor vehicle, such as a police car V. In FIG. 2, the traffic control board 60 is rotated or pivoted about the axis 61 to an orientation facing more to the left side of the vehicle V. Whereas in FIG. 3, the traffic control board 60 is rotated about axis 61 to an orientation that is visible more to the right side of the vehicle V. As best seen in FIG. 3, the plurality of lights 62 on the face 64 of the traffic control board 60 are arranged in a conventional manner that accommodates lighting of selected ones of the lights 62 to form a left arrow, a right arrow, both left and right arrows, or other displays. For example, the shaded lights 62 in FIG. 3 display a right pointed arrow. The traffic control board 60 can, of course, be rotated to face any orientation between left-facing and right-facing, such as to face rearwardly (not shown) and the like. As also show in FIG. 5, the mast 50 that supports the traffic control board 60 can be collapsed or folded downwardly to stow the traffic control board 60 in a lower profile storage position in which it causes less wind resistance and is not so likely to hit an overhead obstruction as the vehicle V is being driven.

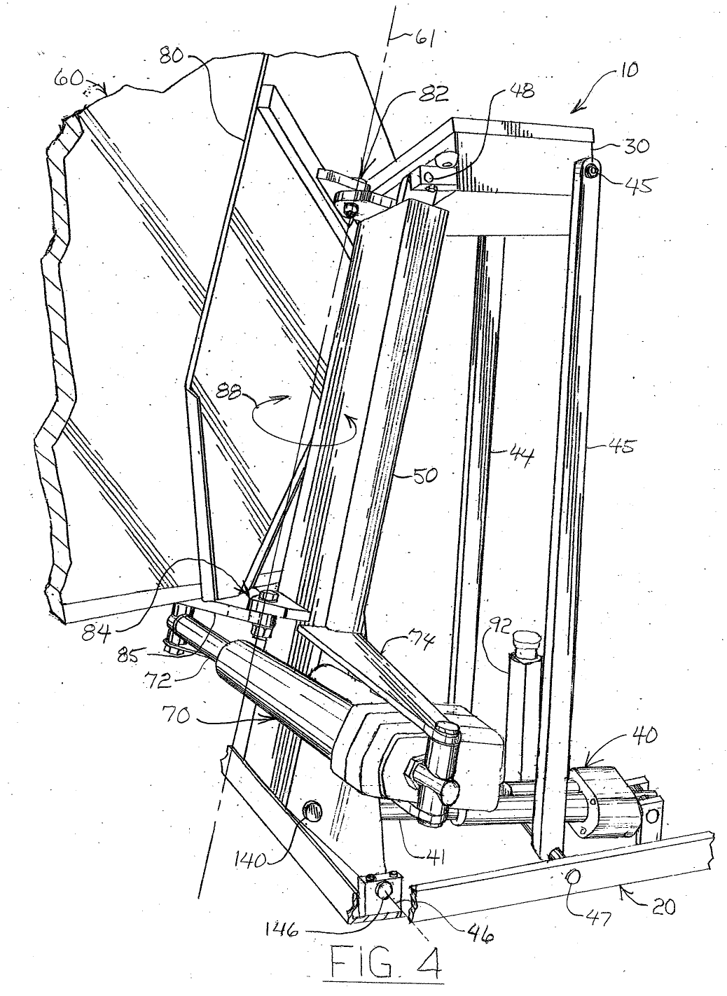

Referring now primarily to FIGS. 1 and 4, with secondary reference to FIGS. 1, 2, and 5, the mount 10 comprises a base 20 adapted for mounting on the roof on top of a vehicle V, the mast 50, and a lift assembly 40 for lifting the mast 50 from the stowed position shown in FIG. 5 to the raised positions show in FIGS. 1-4. These and other components of the mount 10 are similar to those shown and described for the roof-mounted flood light assembly of U.S. Pat. No. 5,203,621, which is incorporated herein by reference. Essentially, the lift assembly can include an electrical or hydraulic actuated, extendable and retractable ram or piston 41 that is connected to a point or shaft 140 on the mast 50 to pivot the mast up and down about a pivot axis 46 defined by one or more pivot pins 146, as indicated by arrow 96 in FIG. 1. The mast 50 can, but does not have to be, given additional support or stabilization by one or more struts 44, 45, which, together with an end platform 30, the mast 50, and the base 20, create a parallelogram structure that raises and lowers in unison as shown by arrow 96 by pivoting on pins 47, 49 as the mast 50 and platform 30 pivot on pins 46, 48. The base 20 can be in any suitable form that has sufficient structural strength to support the mast 50 and traffic flow board 60 and the lift assembly 40. In the example shown in FIG. 1, the base 20 is comprised of two longitudinal frame members 22, 23 fastened at their ends to two transverse frame members 24, 25. Soft or rubber-like mounting pads 48 under opposite ends of the transverse frame members 24, 25 facilitate mounting the base 20 on the vehicle V.

As best seen in FIGS. 1 and 4, the traffic flow board 60 is fastened to a mounting plate 80, which is pivotally mounted by hinges 82, 84 to the mast 50. An actuator 70 of some kind, for example, an electrical or hydraulically powered, extendable ram or piston 72 attached at one end to a bracket 74 on the mast 50 and at the other end to the mounting plate 80 or to a portion or extension 85 of the hinge 84 that is connected to the mounting plate 80 or to the board 60, is used to pivot the board 80 about the axis 61, as indicated by the arrow 88.

A plurality of support struts 92, 93, 94, 95 project upwardly from the base 20 to provide stabilizing support to the traffic control board 60, when it is folded down to the stowed position, as shown in FIG. 5.

The details, components, and structures described above are examples of implementations of the invention, but other structures and components could also be used to implement the invention, which comprises a base adapted for mounting on a vehicle, a mast that is pivotally mounted to the base with a lift assembly for raising and lowering the distal end of the mast from its lowered, stowed position to its raised, upright position, and back, a traffic flow board pivotally mounted to the mast in a manner that supports the board in an upright position with its lights displaying in a direction substantially parallel to the ground, i.e., substantially perpendicular to the mast, when the mast is in the upright position, and an actuator to pivot the board about an axis that is substantially parallel to the mast and substantially perpendicular to the direction the lights on the board display. Other features of the invention can be discerned from the description above and the accompanying drawings in FIGS. 1-5, which for a part of this description.

The foregoing description is considered as illustrative of the principles of the invention. Furthermore, since numerous modifications and changes will readily occur to those skilled in the art, it is not desired to limit the invention to the exact construction and process shown and described above. Accordingly, resort may be made to all suitable modifications and equivalents that fall within the scope of the invention. The words “comprise,” “comprises,” “comprising,” “include,” “including,” and “includes” when used in this specification are intended to specify the presence of stated features, integers, components, or steps, but they do not preclude the presence or addition of one or more other features, integers, components, steps, or groups thereof.

The embodiments of the invention in which an exclusive property or privilege is claimed are defined as follows:

1. Traffic control board apparatus, comprising:
a base that is sized and shaped for mounting on a vehicle;
a mast that has a proximal end and a distal end, wherein the proximal end of the mast is mounted pivotally to the base in such a manner that the proximal end of the mast is pivotal about a horizontal axis so that the distal end of the mast is movable from a collapsed position adjacent the vehicle to an extended position above the vehicle;
a lift assembly mounted on the base and connected to the mast, said lift assembly being operative to pivot the mast about said horizontal axis to lift the distal end of the mast to the extended position and to lower the distal end of the mast to the collapsed position;
a traffic control board comprising a panel with a light display mounted pivotally to the mast in an orientation such that the light display is visible for a horizontal distance from the vehicle, wherein the traffic control board is pivotal about an orientation axis that is substantially parallel to the mast such that the traffic control panel is pivotal about the orientation axis so that the light display can be made visible from any of a variety of horizontal directions; and
an orientation assembly mounted on the mast that is operative to pivot the traffic control board about the orientation axis.

2. The traffic control board apparatus of claim 1, including a mounting plate that is mounted pivotally to the mast by pivotal hinges that define said orientation axis, wherein the traffic control board is mounted pivotally to the mast by attachment of the traffic control board to the mounting plate.

3. The traffic control board apparatus of claim 2, wherein the orientation assembly is connected to the mast and to the mounting plate to enable the orientation assembly to impart pivotal movement to the mounting plate in relation to the mast about the orientation axis.

4. The traffic control board apparatus of claim 3, wherein the mast includes a collapsible parallelogram structure.

5. Traffic control board apparatus, comprising:
a base adapted for mounting on a vehicle;
a mast that is pivotally mounted to the base with a lift assembly for raising and lowering the distal end of the mast from its lowered, stowed position to its raised, upright position and back again;
a traffic flow board pivotally mounted to the mast in a manner that supports the traffic control board in an upright position with its lights displaying in a direction substantially parallel to the ground and perpendicular to the mast when the mast is in the upright position; and
an actuator to pivot the traffic control board about an axis that substantially parallel to the mast and substantially perpendicular to the direction from which the lights on the traffic display board are visible.
